(19) United States
(12) Patent Application Publication
(10) Pub. No.: US 2010/0214397 A1
(43) Pub. Date: Aug. 26, 2010

(54) Method and system of forming a stereo image

(76) Inventor: Evgeny Borisovich Gaskevich, Troitsk (RU)

Correspondence Address: LADAS & PARRY LLP, 26 WEST 61ST STREET, NEW YORK, NY, 10023, US

(21) Appl. No.: 11/921,246

(22) PCT Filed: Jun. 21, 2006
(86) PCT No.: PCT/RU2006/000324

§ 371 Date: May 11, 2010

(30) Foreign Application Priority Data
Jul. 13, 2005 (RU) 2005122254

(51) Int. Cl. H04N 13/04

(52) U.S. Cl. 348/60; 348/E13.075

(57) ABSTRACT

The invention relates to systems for performing color stereoscopic images and can be used for creating stereoscopic computer monitors and TV sets. A technical result consists in performing a color stereoscopic image with high sharpness without geometric distortions, with a maximum of resolution and a wide field of vision.

A concept of the invention consists in that produced are the “left” and “right” color frames of a stereoscopic pair, decomposing the “left” and “right” color frames of the stereoscopic pair with reference to two different kits of primary colors Z₁ and Zᵣ, respectively (a primary color kit includes at least three spectral independent colors), displaying the “left” and “right” color frames of the stereoscopic pair using the kits of primary colors Z₁ and Zᵣ, respectively (“left” frame—with the use of the kit of primary colors Z₁, “right” frame—with the use of the kit of primary colors Zᵣ), filtering the colors of kits Z₁ and Zᵣ such that a viewer can see the “left” frame of the stereoscopic pair by the left eye and cannot see the “right” one and can see the “right” frame of the stereoscopic pair by the right eye and cannot see the “left” one.

### FIELD OF THE INVENTION

The invention relates to systems for producing color stereoscopic images and can be used for creating stereoscopic computer monitors and TV sets, stereocinematographs and other analog and digital information display means.

Predominantly the invention is designed for creating color stereoscopic liquid-crystal monitors and TV sets.

Besides, the invention can be used for demonstrating stereoscopic information at exhibitions, in museums, theatres and in concert halls and gymnasia, at stadiums and sports grounds, in video advertisements, machines, play and simulator systems and in other fields of technology which call for using color stereoscopic images.

### STATE OF THE ART

Known from states of the art are “matrix” systems (screens, displays) wherein an image is produced on a matrix of chromatogenic elements that is just a screen (i.e. the image is produced on a screen watched by an observer). These are TV sets, computer monitors and other systems designed for individual use in general. The main types of matrix (screens, displays) usable in said systems—liquid-crystal clearance displays (LCD-screens), plasma panels (PDP-screens), kinescopes (CRT-screens) and other types of matrices of chromatogenic elements: light-emitting diode displays (LED-screens), to mention only few.

Known from state of the art are few methods of producing a stereoscopic image (glasses methods—polarization and shutter, no glasses methods, raster, and so on and so forth). However, all the existing methods have defects which do not allow to use them for creating “matrix” systems of color stereoscopic image reproduction, suitable for practical use and wide replication. The best illustration of this statement is afforded by inaccessibility of color stereoscopic liquid-crystal, plasma or kinescope monitors and TV sets in the consumers' market, whilst demand therefor would be very great. Some methods of producing the stereoscopic image are used currently in projection-type systems of reproduction of color stereoscopic images.

Let us consider the existing methods of producing a color stereoscopic image and disadvantages thereof.

Known from state of the art are systems for producing stereoscopic images for separate “glasses” observation of the left and right frames of a stereoscopic pair by observers' left and right eyes, respectively, for which purpose the observers are provided with polarization-type and shutter glasses (cf. the book by N. A. Valus. Stereo: Photography, cinema, television.—Moscow, ISKUSSTVO Publishers, 1986,—263 pages, ill.).

Polarization is used in two variants—linear (for example, for the left eye—vertical; for the right eye—horizontal) and circulat (for example, for the right eye—right, i.e. clock-wise; for the left eye—left, i.e. counterclockwise or vice versa).

Positive effects in using polarization-type or shutter stereoscopic glasses reside in the possibility to simultaneously observe a full color stereoscopic image by a great number of observers in a wide visual angle and also to provide an equal light load on the observer's eyes.

The main defect of linear polarization systems consists in that the incline of the observer's head to the left or to the right appreciably reduces the quality of a stereoscopic effect (results in image bifurcation) and with large angles of inclination the stereoeffect disappears completely. The observer should firmly hold his head such that his eyes are at one horizontal level.

The main defect of systems with circular polarization is that for providing said circular polarization, a rather complicated polarization-type filter is required but not a film (as in the case of the linear polarization). At the same time, the circular polarization has a substantial advantage over linear—incline of the head does not affect the quality of a stereoeffect.

The common defect of all polarization methods consists in that it is not practically feasible to use them for creating “matrix’ systems for producing a color stereoscopic image, for which purpose microscopic polarization-type filters would have to be applied, alternating the directions of polarization, to each pixel of a “matrix” monitor, which is highly complicated from the technological point of view. The use of polarization methods for creating stereoscopic liquid-crystal monitors and TV sets is complicated by also the fact that in a liquid-crystal display, use is made of light that is already polarized. By now the polarization methods are used only for creating projection—type systems for producing the color stereoscopic image.

The main defect of a shutter method is eye fatiguability because of a low frequency flickering of images on a screen and environments, which fact causes irritation and even a disease of eyes in a long watch of stereoscopic images. An increase in the frequency of flickers up to 80 frame changes per sec and more (which is required for imperceptibility of flickers) is associated with appreciable technological difficulties because of limitations related to the design and production of “matrix” monitors.

Also, known from state of the art are stereoscopic no-glasses projection-type systems with lens-raster stereoscopic screens whose main defect is the necessity to firmly hold the observer's head in the zones of selective stereoscopic vision. The width of each zone of vision does not exceed the distance between the eye pupils whereby an eye shift relative to the center of the zone two and more cm leads to markedly reducing brightness of the image observed. If the observer changes a position and comes out of a zone of vision, a stereoscopic effect is lost. The observer's stringent fixed position relative to the zones of vision even for several minutes causes discomfort—inconvenience, quick fatiguability because the observer has to sit immovably and visually seek all the time the most favourable angle of approach (the center of a zone of vision) of a clear observation of the stereoeffect.

Besides, known from state of the art is a method of producing stereoscopic images based on the use of various colors for the left and right frames of a stereoscopic pair, for example the left frame—red, and the right frame—green; projection is made onto one screen and glasses with filters are used—red and green. Thus, the observer sees by one eye only red (left) frame and only green (right) frame with the other and sees, as a result, a 3-D monochromatic image. The main defect of this method consists in that it is not helpful in providing a color stereoscopic image with natural color transmission.

The technical result being attained by the present invention consists in creating a method and a system for producing color stereoscopic images. Another technical result of the claimed invention consists in creating a method and a system providing for producing color stereoscopic images with high sharpness, with no geometric distortions, with a maximum of resolving power and a wide field of vision.

### ESSENCE OF THE INVENTION

The claimed technical result is achieved using a method of producing stereoscopic images comprising the following steps:
1. producing “left” and “right” frames of a stereoscopic pair;
2. decomposing “left” and “right” frames of a stereoscopic pair of two different kits of primary colors (two different color spaces): “left” frame—of a kit of primary colors Z₁, “right” frame—of a kit of primary colors Zᵣ (none of the colors of Z₁ coincides with none of the colors of Zᵣ, FIG. 1).
3. displaying on a screen viewed by an observer the “left” and “right” frames of a stereoscopic pair using kits of primary colors Z₁ and Zᵣ, respectively;
4. filtering the colors of kits Z₁ and Zᵣ such that the observer can see the “left” frame of a stereoscopic pair by his left eye and cannot see “right” one and can see the “right” frame of the stereoscopic pair by his right eye and cannot see “left” one.

In one of the alternative embodiments of the invention, the “left” and “right” frames of a stereoscopic pair are displayed with the aid of a display means, and filtration is carried out using at least two light filters, of which one transmits the colors of a kit Z₁ and does not transmit the colors of a kit Zᵣ while the other light filter transmits the colors of Zᵣ and does not transmit the colors of Z₁.

In another alternative embodiment of the invention, the light filter transmitting the colors of a kit Z₁ and not transmitting the colors of a kit Zᵣ is arranged between a display device and the observer's left eye and the light filter transmitting the colors of a kit Zᵣ and not transmitting the colors of a kit Z₁ is arranged between the display device and the observer's right eye.

Light filters can be executed as special goggles, contact lenses and other appliances.

The technical result is attained also owing to the fact that a system for producing a stereoscopic image comprises: a display device for producing and displaying the “left” and “right” frames of a stereoscopic pair using kits of primary colors Z₁ and Zᵣ, respectively, and a filtering device designed for the separate observation of the “left” and “right” frames of said stereoscopic pair by the observer's different eyes by filtering the colors of kits Z₁ and Zᵣ.

In one of the alternative embodiments of the invention a display device comprises a matrix of chromatogenic elements corresponding to two kits of primary colors Z₁ and Zᵣ.

In another alternative embodiment of the invention, a display device comprises a matrix of chromatogenic elements and a matrix of light filters corresponding to two kits of primary colors Z₁ and Z₂ and arranged over the matrix of chromatogenic elements.

In still another alternative embodiment of the invention a matrix of light filters corresponding to two kits of primary colors Z₁ and Zᵣ is arranged such that the subpixels of each color to be produced by the elements of the matrix of chromatogenic elements and light filters of said matrix of light filters are uniformly distributed over a display device.

In a further alternative embodiment of the invention, a filtering device comprises at least two light filters, of which one transmits the colors of a kit Z₁ and does not transmit the colors of a kit Zᵣ while the other light filter transmits the colors of a kit Zᵣ and does not transmit the colors of a kit Z₁ whereby the light filter transmitting the colors of Z₁ and not transmitting the colors of Zᵣ is arranged between a display device and the observer's left eye and the light filter transmitting the colors of Zᵣ and not transmitting the colors of Z₁ is arranged between the display device and the observer's right eye.

In a further alternative embodiment of the invention, the matrix of chromatogenic elements can be a matrix of liquid-crystal chromatogenic cells (LCD-screen), plasma chromatogenic cells (PDP-screen), luminophor chromatogenic elements (CRT-screen), light-emitting diode chromatogenic cells (LED-screen), plastic chromatogenic cells (LEP-screen) or as a matrix of organic electroluminescent chromatogenic cells (OLED-screen).

In a further alternative embodiment of the invention, a system is further adapted to produce a dimetric image.

### BRIEF DESCRIPTION OF THE DRAWINGS

FIG. 1 shows a kit of primary colors and respective color spaces on the x and y coordinates of a model CIP. For example, a kit of primary colors Z₁={R₁, G₁, B₁}, a kit of primary colors Zᵣ={R₂, G₂, B₂} or vice versa.

FIG. 2 shows a color stereoscopic image produced with decomposition of the “left” and “right” frames of a stereoscopic pair of various kits of the primary colors in “matrix” systems as an example of two kits of three primary colors each.

FIG. 3 shows some methods of arranging subpixels on a screen and their conventional combination in pixels (p) usable in standard “matrix” systems—LCD-screens, PDP-screens, CRT-screens, to mention just few.

FIG. 4 shows some methods of arranging subpixels on the matrix of chromatogenic elements, designed for reproducing two kits of primary colors Z₁ and Zᵣ—stereoscopic LCD-screen, PDP-screen, CRT-screen—and methods of conventionally combining the subpixels in pixels (p′, p″-pixels corresponding to the kits of primary colors Z₁ and Zᵣ).

FIG. 5 shows methods of superimposing an additional matrix of light filters on a matrix of chromatogenic elements reproducing one kit of primary colors for producing subpixels reproducing two kits of primary colors Z₁ and Zᵣ, and methods of conventional combination of subpixels in pixels (p′, p″-pixels corresponding to the kits of primary colors Z₁ and Zᵣ).

### DETAILED DESCRIPTION OF THE INVENTION

The ability of man to see a stereoscopic (3D) image in a near zone (conventionally up to 5 m) is first of all dependent on the binocular mechanism of human eyesight. When we look at an object spaced close by, two different dimetric images are produced on the retina of left and right eyes, which are perceived by the brain as a single 3D image. Accordingly, in case of two dimetric images (frame) corresponding to a viewpoint by the left and right eyes (a so-called “stereoscopic pair”) and of the left eye seeing only the “left” frame of the stereoscopic pair and the right eye—only the “right” frame of the stereoscopic pair, the stereoscopic (3D) image can be produced.

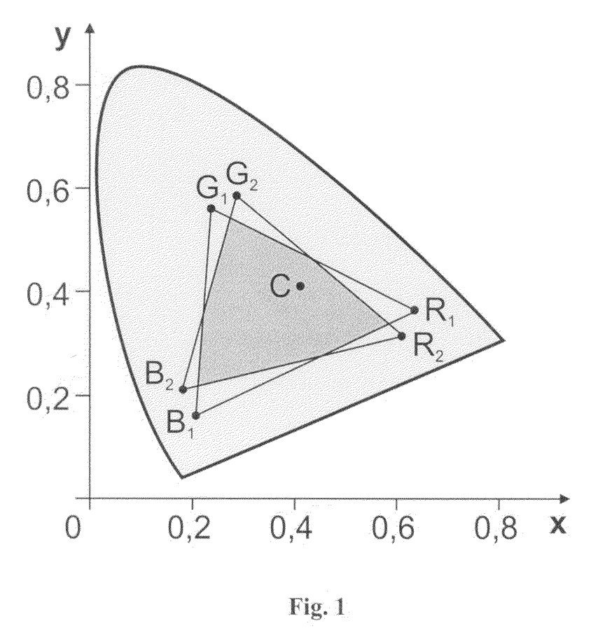

A great number of colors perceived by main can be plotted on the x and y coordinates of a model CIP. FIG. 1 (a light-gray region). Any kit of three (and more) spectral independent colors (primary colors) specifies a color space (a triangle on the X and Y coordinates of the model CIP) whose all colors can be produced by way of combining said primary colors in different proportions. For example, FIG. 1 shows two color spaces defined by two different kits of three primary colors (red, green, dark blue)—kit Z₁={R₁, G₁, B₁} and Z₂={R₂, G₂, B₂}. Any color C getting into an area of intersection of these color spaces (dark gray region in FIG. 1) can be decomposed both according to Z₁ and Z₂.

For a color stereoscopic image to be produced, use is made of a display device to produce the “left” and “right” frames of a stereoscopic pair, decomposing the “left” and “right” frames of the stereoscopic pair according to two different kits of primary colors Z₁ and Zᵣ, respectively, and both frames are then displayed, using a display means, onto a screen seen by a viewer and what is more the “left” frame is displayed using Z₁ and the “right” frame is displayed using Zᵣ.

A display device can be any device allowing to reproduce a color dimetric image using both kits of primary colors Z₁ and Zᵣ. In one alternative embodiment of the invention, the display device comprises a matrix of chromatogenic elements corresponding to two kits Z₁ and Zᵣ. In another alternative embodiment of the invention, a display device comprises a matrix of chromatogenic elements and a matrix of light filters corresponding to two kits of primary colors Z₁ and Zᵣ arranged over the matrix of chromatogenic elements.

Then the colors of kits Z₁ and Zᵣ are filtered using a filtering device such that the viewer can see the “left” frame of a stereoscopic pair by his left eye and cannot see the “right” one and can see the “right” frame by the right eye and cannot see the “left” one. The filtering device is a set of at least two light filters—“left” light filter transmitting the colors of the kit Z₁ and not transmitting the colors of Zᵣ and the “right” light filter transmitting the colors of a kit Zᵣ and not transmitting the colors of Z₁. More, the light filters are positioned such that the light filter transmitting the colors of Z₁ and not transmitting the colors of Zᵣ is positioned between the observer's left eye and the display device and the light filter transmitting the colors of Zᵣ and not transmitting the colors of Z₁ is positioned between the observer's right eye and the display device. Thus, the left eye sees only the “left” frame of the stereoscopic pair produced by the primary colors of the kit Z₁ and the right eye—only the “right” frame of the stereopair produced by the primary colors of the kit Zᵣ, which fact allows the observer to see a color stereoscopic (3D) image.

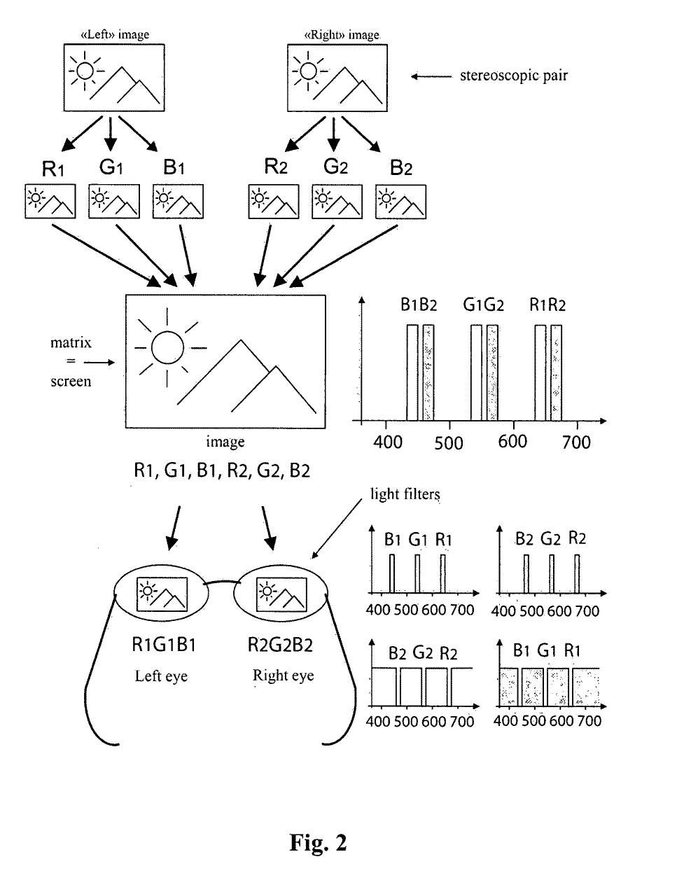

FIG. 2 illustrates the afore-described method of cases where use is made of two kits of three primary colors:

Z₁={R₁, G₁, B₁} and Z₂={R₂, G₂, B₂}

In one of the alternative embodiments of the invention, a filtering device can be implemented in the form of a user light filter for individual use—special glasses, contact lenses, to mention only few.

Be it noted that user light filters can be three types—“for transmission”, “for absorption” and intermediate variants.

“Transmission” light filters transmit narrow spectral bands corresponding to one of the kits of primary colors (Z₁ and Zᵣ) and do not transmit other spectral regions. Thus, said light filters obscure the environments and permit the viewer to see only the image on a screen (accordingly, the left eye sees the “left” frame of a stereoscopic pair and does not the “right” one; the right eye sees the “right” frame of the stereopair and does not see the “left” one).

“Absorption” light filters absorb narrow spectral bands corresponding to one of the kits of primary colors (the left absorbs the colors of a kit Zᵣ, the right—Z₁) and transmit the remaining spectral regions. Thus, the “absorption” light filters do not obscure the environments and allow to see both an image on the screen (accordingly, the viewer's left eye sees the “left” frame of a stereoscopic pair and does not see the “right” one; the right eye sees the “right” frame of the stereopair and does not the “left” one) and the environments.

The intermediate variants of light filters may have arbitrary transmission spectra only if the “left” light filter transmits the colors of a kit Z₁ and does not transmit those of Zᵣ; the “right” light filter transmits the colors of a kit Zᵣ and does not transmit those of Z₁.

A system for producing a color stereoscopic image will now be described below with reference to the designs of LCD-. PDP- and CRT-screens for producing the color stereoscopic (3D) image.

Constructions of LCD-, PDP- and CRT-Screens for Producing Color Stereoscopic Image.

1. Stereoscopic LCD-Screen Construction (LC-Screen)

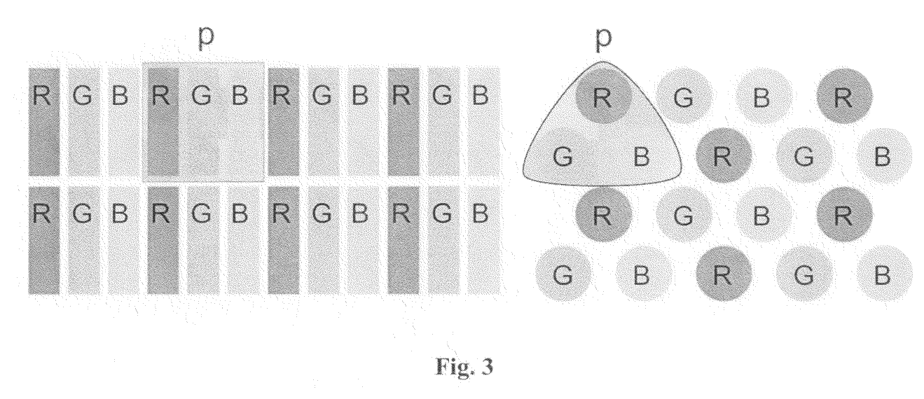

As known, in a standard LCD-screen (TV set, monitor) a color image is produced in the following manner. On a matrix of liquid-crystal cells each capable of changing transmittance thereof under action of a voltage applied thereto is superimposed a matrix of microscopic light filters of primary colors (usually red, green and dark blue). The cells and light filters applied thereto can be strips, circles, etc., with a typical dimension in a mm fraction. Every chromatogenic pair “cell+light filter” is normally called subpixel. The subpixels of each color are uniformly distributed over the screen. Usually the subpixels are conventionally combined in groups (one subpixel of each color) which are called pixels. Some of the methods of arranging the subpixels on the screen and combining same in the pixels are shown in FIG. 3.

An instrument panel lamp is mounted behind a screen.

Changing a degree of LC-cell transmittance, one can regulate the intensity of glow of the corresponding subpixels. The light of the subpixels of various colors is mixed in the viewer's perception, which permits producing any color image on the screen. It is assumed that each and every pixel reproduces a definite color (by mixing the primary colors from the constituent subpixels thereof) and the pixels of various colors produce the color image on the screen.

For an LCD-screen to be used for producing a color stereoscopic image, its construction should be changed according to the alternative embodiments of the invention claimed.

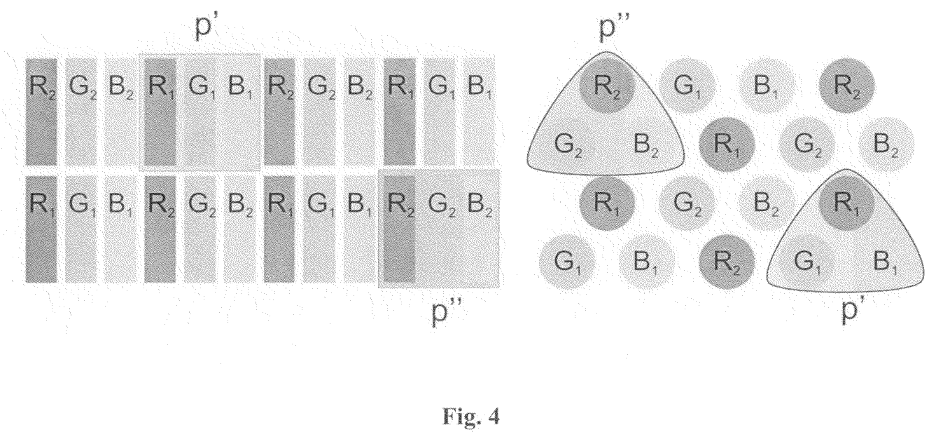

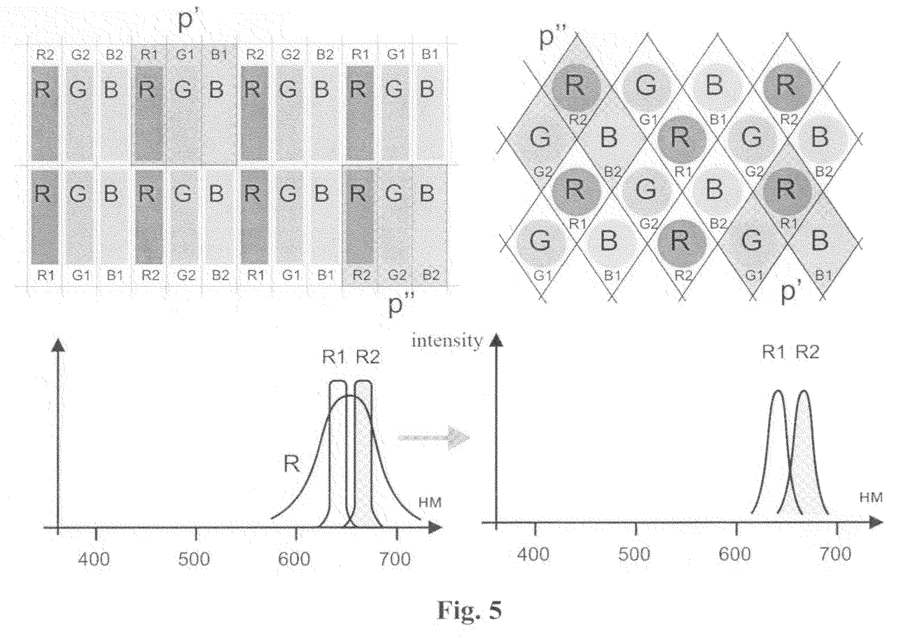

Variant I. In one variant of realization of a color stereoscopic LCD-screen, a matrix of LC-cells is superposed with a matrix of light corresponding to two kits of primary colors—Z₁ and Zᵣ such that the sulpixels of each color are uniformly distributed over the screen (or, which is equivalent), pixels p′ and p″ corresponding to Z₁ and Zᵣ are uniformly distributed over the screen). This can be done by one of the methods (FIG. 4) or any other similar method. For example, the pixels p′ and p″ can alternate in columns, in lines, staggered (FIG. 5) and so on, and so forth. The “left” and “right” frames of a stereoscopic pair are reproduced on the screen: one using the pixels p′, the other—p″. Light filters transmission spectra should be narrow enough so that using user light filters arranged between the screen and the user's eyes (special glasses, contact lenses, etc.) the “left” and “right” frames of the stereopair could be separated particularly well.

Variant 2. In another variant of realization of a stereoscopic LCD-screen, a normal LCD-screen is superposed with an additional matrix of light filters which “cut-off” the transmission spectra of standard light filters of the LCD-screen, thus producing two types of subpixels—“left” and “right”. For example, a light filter R1 “cuts off” the transmission spectrum of a standard light filter R, right-hand, producing a subpixel R₁ of a pixel p′, and a light filter R2 “cuts off” a radiation spectrum of the standard light filter R, producing a subpixel R₂ of a pixel p″, FIG. 5.

2. Stereoscopic PDP-Screen (Plasma Panel) Construction

Variants of realization of a stereoscopic PDP-screen are similar to Variants 1 and 2 of execution of a stereoscopic LCD-screen except that instead of a matrix of liquid-crystal cells, use is made of a matrix of plasma chromatogenic cells reproducing two kits of primary colors ((similar to FIG.4) or on an ordinary plasma panel is superposed a matrix of light filters which “cut off” the radiation spectra of standard luminophors of plasma chromatogenic cells to the right and to the left thereby to produce subpixels corresponding to two kits of primary colors (similar to FIG. 5).

3. Construction of Stereoscopic CRT-Screen (Kinescope)

The construction of a stereoscopic CRT-screen is similar to the embodiments of a stereoscopic LCD-screen except that instead of a matrix of LC-cells, use is made of the CRT-screen (kinescope, cathode-ray tube) with a matrix of luminophors reproducing two kits of primary colors (similar to FIG. 5) or a normal CRT-screen is applied with a matrix of light filters which “cut off” the radiation spectra of standard luminiphors to the left and to the right, thus producing subpixels corresponding to two kits of primary colors (similar to FIG. 5).

4. Other stereoscopic “matrix” systems (screens, displays)

The constructions of light-emitting displays (LED-screens), plastic displays (LEP-screens), organic electroluminescent displays (OLED-screens), etc., designed for producing a color stereoscopic (3D) image of the present invention are similar to those mentioned above to take account of the specific features of execution of the given systems.

Besides, all the above-described systems for producing a color stereoscopic image can further be adapted to produce dimetric images by means of simple structural changes, which will contribute to universality of the use of said systems in various technical fields. For example, in a color stereoscopic monitor, provision can be made of both a mode of stereoscopic image for operations with three-dimensional graphics, watch of stereofilms, entertainments, etc., and a mode of dimetric image (with double picture resolution) for operations with documents or highly detailed dimetric images.

1. A method of producing a color stereoscopic image comprising:
producing the “left” and “right” color frames of a stereoscopic pair;
docomposing the “left” and “right” color frames of a stereoscopic pair with reference to two different kits of primary colors Z₁ and Zᵣ, respectively,
displaying the “left” and “right” color frames of the stereoscopic pair using kits of primary colors Z₁ and Zᵣ, respectively,
filtering colors of the kits Z₁ and Zᵣ such that a viewer can see the “left” color frame of the stereoscopic pair by his left eye and cannot see the “right” one and can see the “right” color frame of the stereoscopic pair by the right eye and cannot see the “left” one.

2. The method of claim 1, characterized in that filtration is carried out using at least two light filters, of which one transmits the colors of a kit Z₁ and does not transmit the colors of a kit Zᵣ while the other kit transmits the colors of the kit Zᵣ and does not transmit the colors of the kit Z₁.

3. The method of claim 2, characterized in that the “left” and “right” frames of a stereoscopic pair are displayed by a display means.

4. The method of claim 3 characterized in that a light filter transmitting the colors of a kit Z₁ and not transmitting the colors of Zᵣ is arranged between a display device and the viewer's left eye and the light filter transmitting the colors of the kit Zᵣ and not transmitting the colors of Z₁ is arranged between the display device and the viewer's right eye.

5. A system for producing a stereoscopic image comprising a display device designed for producing and displaying the “left” and “right” frames of a stereoscopic pair using kits of primary colors Z₁ and Zᵣ, respectively, and a filtering device for separately observing the “left” and “right” frames of the stereoscopic pair by the viewer's different eyes by filtration of said kits Z₁ and Zᵣ.

6. The system of claim 5, characterized in that the display device comprises a matrix of chromatogenic elements corresponding to two kits of primary colors Z₁ and Zᵣ.

7. The system of claim 5, characterized in that the display device comprises a matrix of chromatogenic elements and a matrix of light filters corresponding to two kits of primary colors Z₁ and Zᵣ and arranged over the chromatogenic elements matrix.

8. The system of claim 6, characterized in that the matrix of chromatogenic elements corresponding to two kits of primary colors Z₁ and Zᵣ is arranged such that the chromatogenic elements of each and every color are uniformly distributed over the display device.

9. The system of claim 7, characterized in that the matrix of light filters corresponding to two kits of primary colors Z₁ and Zᵣ is arranged such that subpixels of each color produced by the elements of a matrix of chromatogenic elements and light filters of the light filters matrix are uniformly distributed over a display device.

10. The system of claim 5, characterized in that the filtering device consists of at least two light filters, of which one transmits the colors of the kit Z₁ and does not transmit colors of Zᵣ and the other light filter transmits the colors of the kit Zᵣ and does not transmit the colors of Z₁.

11. The system of claim 10, characterized in that the a light filter transmitting the colors of the kit Z₁ and not transmitting the colors of Zᵣ is arranged between a display device and the viewer's left eye and the light filter transmitting the colors of the kit Zᵣ and not transmitting the colors of Z₁ is arranged between the display device and the viewer's right eye.

12. The system of claim 1, characterized in that it is adapted to further produce a dimetric image.

13. The system of any one of claims 6 to 12, characterized in that the matrix of chromatogenic elements is implemented in the form of a matrix of LC chromatogenic cells (LCD-screen).

14. The system of any one of claims 6 to 12, characterized in that the chromatogenic elements matrix is implemented in the form of a matrix of plasma chromatogenic cells (PDP-screen).

15. The system of any one of claims 6-12, characterized in that the chromatogenic elements matrix is a matrix of luminophor chromatogenic elements (CRT-screen).

16. The system of any one of claims 6 to 12, characterized in that the chromatogenic elements matrix is a matrix of light-emitting diode chromatogenic cells (LED-screen).

17. The system of any one of claims 6 to 12, characterized in that the chromatogenic elements matrix is a matrix of plastic chromatogenic cells (LEP-screen).

18. The system of any one of claims 6 to 12, characterized in that the chromatogenic elements matrix is a matrix of organic electroluminescent chromatogenic cells (OLED-screen).
